(19) United States
(12) Patent Application Publication
(10) Pub. No.: US 2006/0277480 A1
(43) Pub. Date: Dec. 7, 2006

(54) Facilitating communication between user interface components that transmit information in incompatible formats

(75) Inventors: Jeffrey R. Anderson, West Fargo, ND (US); Tristan Cartony, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/145,748

(22) Filed: Jun. 6, 2005

(51) Int. Cl. G06F 3/00

(52) U.S. Cl. 715/762

(57) ABSTRACT

A system that facilitates communication between user interface components (or parts) that transmit information in incompatible formats is provided. The system includes an adapter that receives information in an information communication format of any one of the parts, and transforms the received information into an information communication format of any other one of the parts, thereby facilitating communication between the different parts.

### TECHNICAL FIELD

The present invention generally relates to communication between separate software modules. More particularly, the present invention relates to facilitating communication between user interface components that transmit information in incompatible formats.

### BACKGROUND

One significant feature of modern computer systems is the ability for a computer user to be able to easily access information and programs available for use on the computer system. The aspect of the computer system that allows such user access is called a “user interface.” The various schemes for implementing the user interface are generally categorized by the manner in which the user interacts with the system. For example, in a typical character user interface (ChUI) such as the DOS® operating system, the user inputs text from the keyboard, and the system returns text to the screen. However, in a graphical user interface (GUI), the user can interact with the system by manipulating graphical objects on the display screen. Graphical user interfaces are generally supplied by operating system providers, and also by third parties who design specialized or enhanced interfaces for specific software applications.

In general, user interfaces to specialized software applications comprise screens that include, for example, functions that enable a user to query certain information, update a database with information entered in fields on the screen, etc. A screen with its associated functions is hereinafter referred to as a page.

A page typically includes multiple components or parts that may communicate with each other to carry out different functions. For example, a customer contact page may include a customer information part, which displays names and telephone numbers for different customers, and a phone dialing part, which can receive a user-selected telephone number from the customer information part and dial the received telephone number.

In current user interface systems, different parts are typically designed/programmed to communicate directly with each other and therefore support a single information communication format. Thus, for the above example customer contact page to carry out its dialing function, the customer information part has to send the telephone number in a format that the phone dialing part can receive. Restricting communication between parts to a single format results in a user interface with limited flexibility and prevents an interface developer from incorporating potentially useful components that do not communicate in the “appropriate” format.

### SUMMARY

A system that facilitates communication between user interface components (or parts) that transmit information in incompatible formats is provided. The system includes an adapter that receives information in an information communication format of any one of the parts, and transforms the received information into an information communication format of any other one of the parts, thereby facilitating communication between the different parts.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one illustrative computing environment in which the present invention can be implemented.

FIG. 2 is a block diagram of a user interface having parts with different associated information communication formats in accordance with an embodiment of the present invention.

FIGS. 3 and 4 are screen shots of an example customer contact page that employs parts with different associated information communication formats in accordance with one embodiment of the present invention.

FIG. 5 is a simplified block diagram illustrating communication between parts of the example customer contact page.

FIG. 6 is a flowchart of a method of developing a user interface for accessing programs available for use on a computer system in accordance with an embodiment of the present invention.

### DETAILED DESCRIPTION

Embodiments of the present invention relate, in general, to communication between components or parts of a user interface. More specifically, embodiments of the present invention relate to systems that facilitate communication between user interface components that transmit information in incompatible formats. However, before describing the present invention in greater detail, one illustrative embodiment in which the present invention can be used will be discussed.

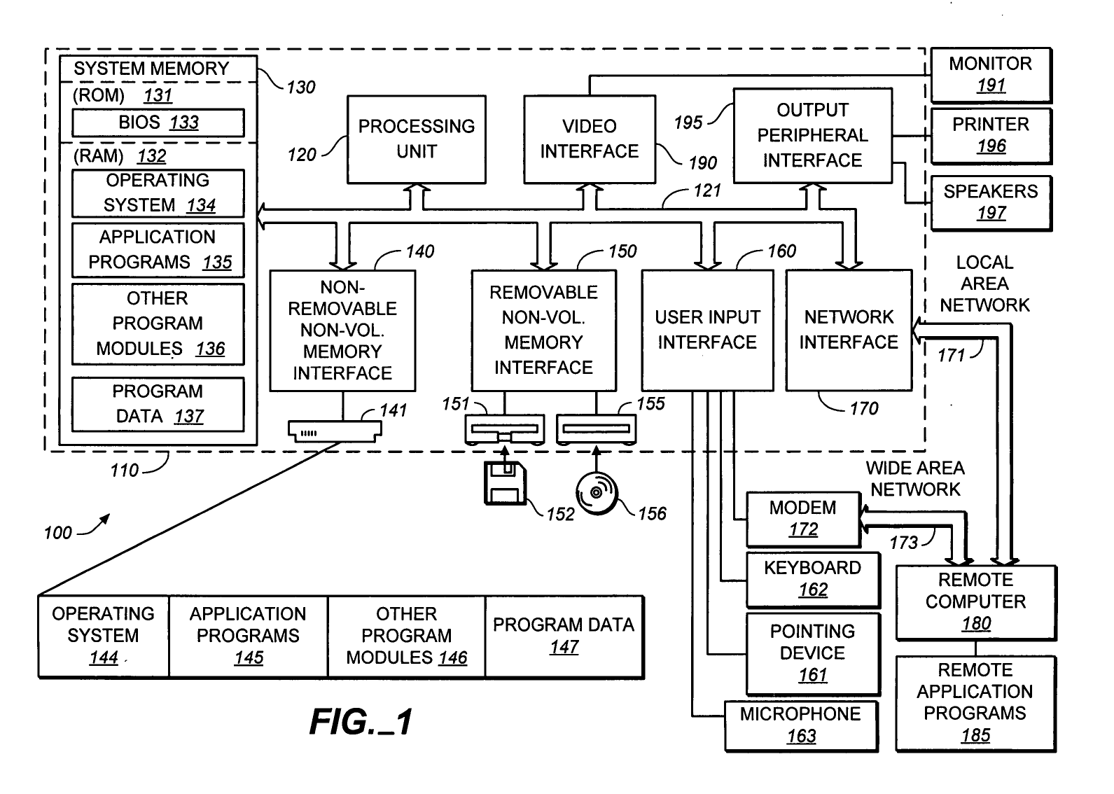

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

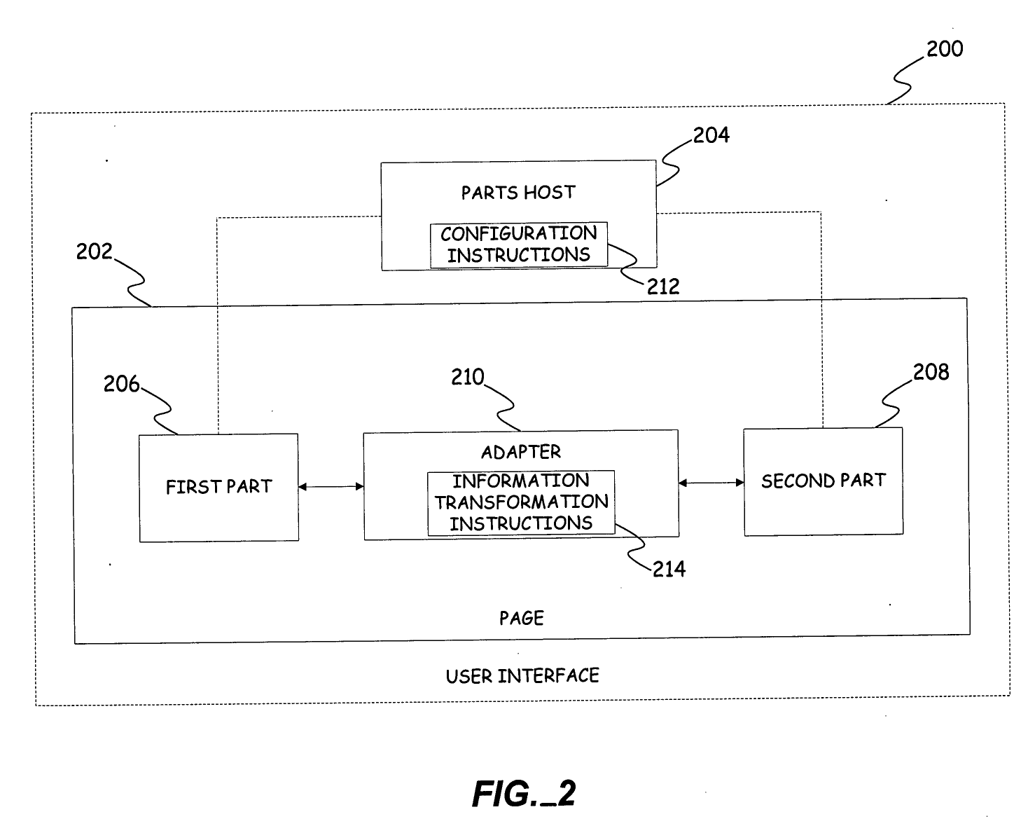

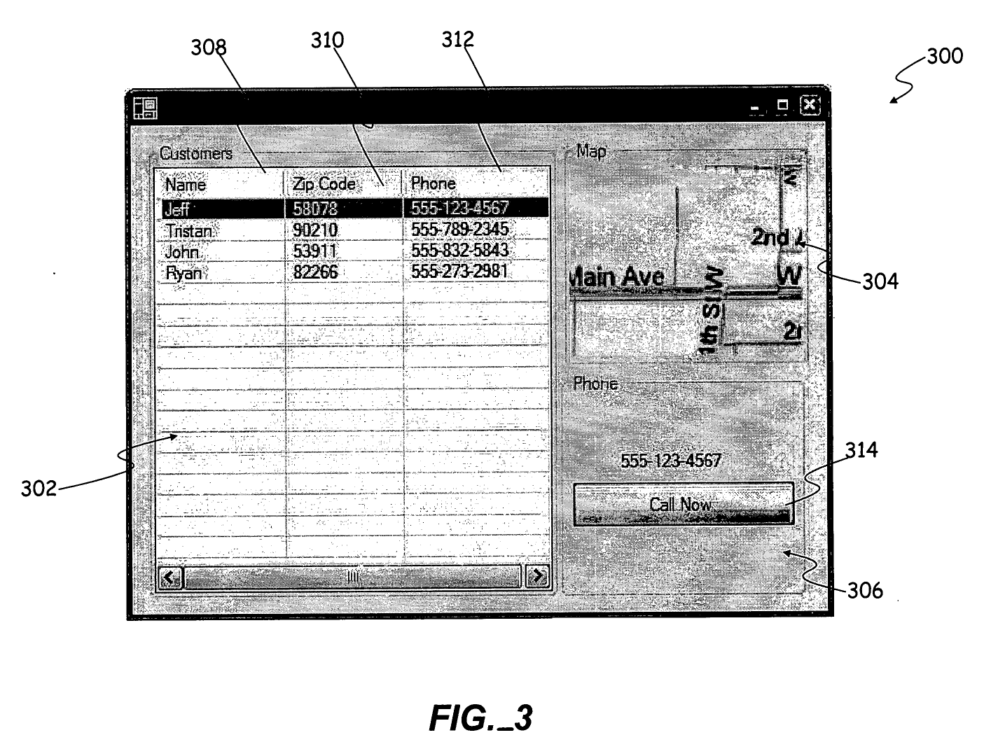

FIG. 2 is a block diagram of a user interface system 200 having parts with different associated information communication formats in accordance with an embodiment of the present invention. Example user interface system 200 includes a page 202 and a parts host 204. As mentioned above, a page includes a screen and its associated functions and therefore a user interface system (such as 200) can include one or more pages. In general, as noted earlier, a page is divided into several functional units or parts. A user interacts with parts of a page, and the individual parts, in turn, usually communicate information between each other. Specific examples of parts are provided further below in connection with FIGS. 3, 4 and 5.

In the example embodiment shown in FIG. 2, page 202 includes a first part 206, which is capable of communicating in a first information communication format, and a second part 208, which is capable of communicating in a second information communication format. Also included in page 202 is an adapter 210, which facilitates communication between first part 206 and second part 208. Adapter 210, which is not visible to a page user, is capable of transforming information transmitted from first part 206 in the first information communication format into the second communication format for receipt by second part 208, and vice versa.

Parts (such as 206 and 208) can be developed independently of each other and stored in separate executable files. These separate executable files are loaded into a “framework” of page 202 at runtime by parts host 204, which includes configuration instructions (user-coded instructions or page-level metadata) 212 that define what parts should be included in page 202, the page framework, locations of the parts in the framework, etc. At runtime, parts host 204 also invokes adapter 210, which includes information transformation instructions 214 that facilitate communication between parts 206 and 208. In some embodiments, information transformation instructions 214 include hard-coded rules for transforming information which can be modified only by changing adapter source code and re-compiling adapter 210. In other embodiments, information transformation instructions 214 include adapter-level metadata that can be modified to implement information transformation rule changes without modifying source code or recompiling adapter 210. In general, adapter 210 can be coded in any appropriate language, such as C++, Java, or C#, and stored in an executable file. Although adapter 210 is shown as a single component within page 202 in FIG. 2, it can be located external to page 202 and can include multiple components that carry out different information transformation functions. Also, in some embodiments, multiple pages can employ a single common adapter. An example page with specific parts is described below in connection with FIGS. 3, 4 and 5.

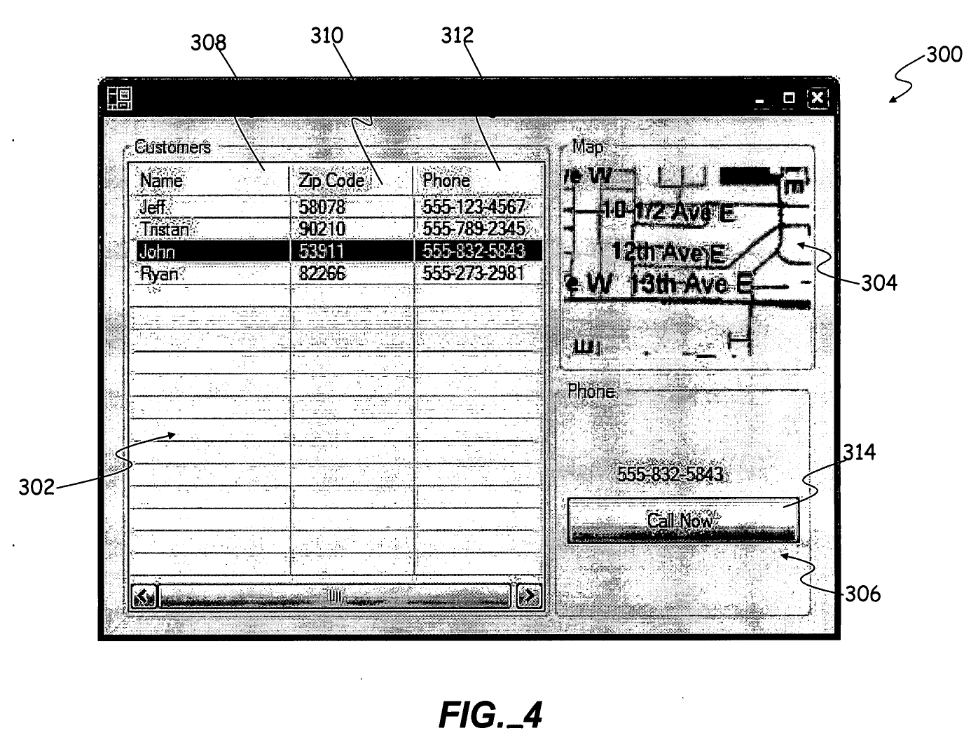

FIGS. 3 and 4 are screen shots of an example customer contact page 300 that employs parts with different associated information communication formats in accordance with one embodiment of the present invention. Referring now to FIG. 3, customer contact page 300 includes a customer information part 302, a map part 304 and a phone dialing part 306. Customer information part 302 includes a number of display lines/rows/records, with each record including a customer name field 308, a zip code field 310 and a phone field 312. Map part 304 is capable of displaying a map for a zip code area, and customer dialing part 306 includes functionality for dialing a telephone number.

Customer contact page 300 is designed such that a zip code and a telephone number for a selected customer, in customer information part 302, are communicated to map part 304 and phone dialing part 306, respectively. As can be seen in FIG. 3, of the four customers displayed in part 302, the first customer, “Jeff,” is currently highlighted or selected and therefore Jeff's zip code is sent to map part 304 and his telephone number is sent to phone dialing part 306. Upon receipt of Jeff's zip code, map part 304 displays a map for his zip code area. Receipt of Jeff's telephone number by phone dialing part 306 results in his phone number being displayed in part 306. A user can click on button 314 (using a mouse, for example) to call Jeff. When a user selects a different name in customer information part 302, information in map part 304 and telephone dialing part 308 change accordingly. The changes in information resulting from selecting a different customer are shown in FIG. 4.

As mentioned above, customer information part 302, map part 304 and phone dialing part 306 have different associated communication formats. For example, customer information part 304 might send out information in the following format:

<Customer>

<Name>Jeff</Name>
<ZipCode>58078</ZipCode>
<Phone>555-123-4567</Phone>

<Customer>

but map part 304 might expect to receive data in the format:

<Location>

<ZipCode>58078</ZipCode>

</Location>

and phone dialing part 306 might expect to receive data in the following format:

<Contact>

<PhoneNumber>555-123-4567</PhoneNumber>

</Contact>

In the above example, customer information part 302 does not send a beginning tag (<Location>) and an end tag (</Location>) that map part 304 expects to receive. Similarly, tags such as <Contact>, </Contact>, <PhoneNumber>, and </PhoneNumber>, which phone dialing portion 306 expects to receive, are not sent by customer information part 302.

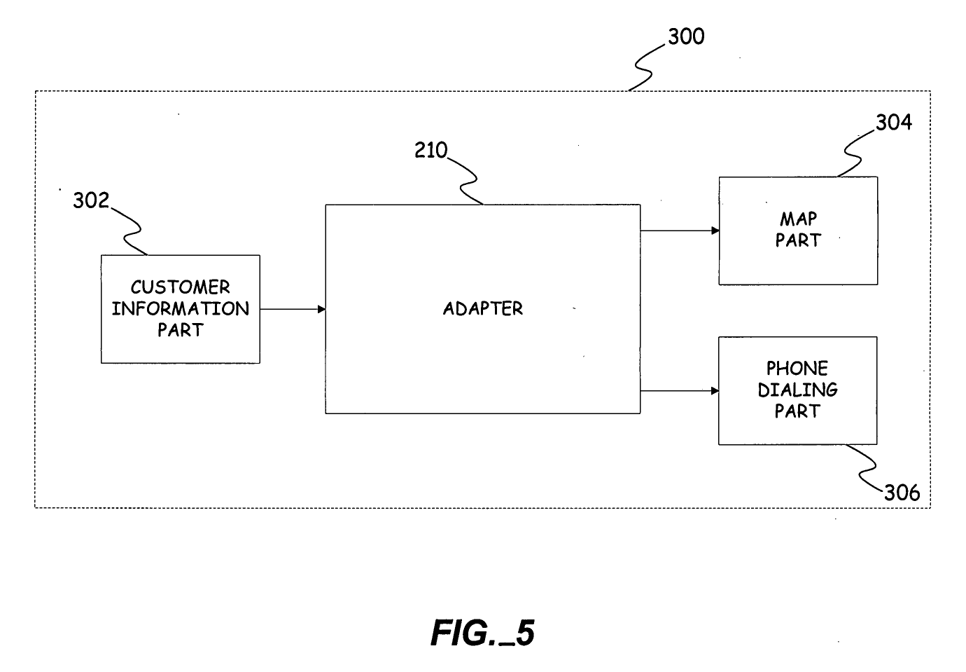

In accordance with an embodiment of the present invention, an adapter (such as 210 (FIG. 2)), which includes instructions for adding/replacing/converting tags sent by customer information part 302 into formats suitable for map part 304 and phone dialing part 306, is loaded into page 300 at runtime to carry out the necessary format conversions. The inclusion of adapter 210 to facilitate communication between parts 302, 304 and 306 of page 300 is shown in FIG. 5.

In some embodiments of the present invention, each part (such as 302, 304, 306) of a user interface communicates in a different format of Extensible Markup Language (XML). In such embodiments, adapter 210 is developed using Extensible Stylesheet Language Transformations (XSLT) or uses XSLT to perform its functions. It is known that XSLT is well suited for transforming XML into other XML documents and therefore if information transformation instructions 214 are written in XSLT, they can be relatively easily updated to accommodate modifications or additions to user interface parts.

In some embodiments of the present invention, adapter 210 includes instructions to convert alphanumeric data into numeric data and vice versa. Such embodiments can employ parts that utilize only numeric data (for example, only telephone numbers) in addition to parts that use alphanumeric data.

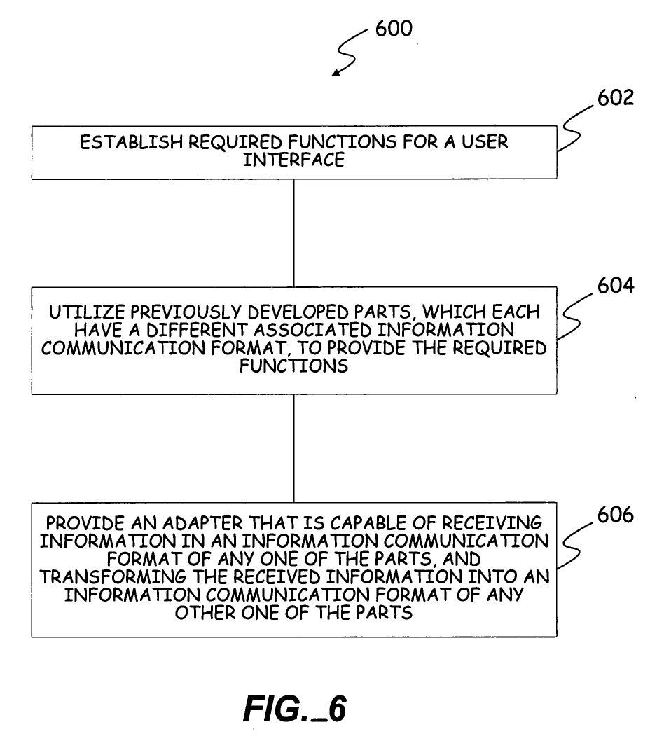

FIG. 6 is a flowchart 600 of a method of developing a user interface for accessing programs available for use on a computer system in accordance with an embodiment of the present invention. At step 602, required functions for the user interface are established. At step 604, previously developed parts, each having a different associated information communication format, are utilized to provide the required functions. Step 606 involves providing an adapter that is capable of receiving information in an information communication format of any one of the parts, and transforming the received information into an information communication format of any other one of the parts. Different techniques, some of which are set forth above, can be employed to carry out the steps shown in flowchart 600 while maintaining substantially the same functionality without departing from the scope and spirit of the present invention.

In general, the present invention does not require parts of a page to be designed/developed in tandem or to communicate directly with each other. Thus, parts developed by different groups or even different companies can be used within the same page or user interface. In essence, the present invention allows for transparent transformation of information to occur, at runtime, during part-based communication.

Although the present invention has been described with reference to particular embodiments, workers skilled in the art will recognize that changes may be made in form and detail without departing from the spirit and scope of the invention. Although the above-described embodiments relate to facilitating communication between user interface components that transmit information in incompatible formats, the principles of the present invention can be employed, in general, to facilitate communication between software components that transmit information in incompatible formats.

What is claimed is:

1. A user interface for accessing programs available for use on a computer system, the user interface comprising:
a plurality of parts, with each one of the plurality of parts having a different associated information communication format; and
an adapter configured to receive information in an information communication format of any one of the plurality of parts, and to transform the received information into an information communication format of any other one of the plurality of parts, thereby facilitating communication between individual parts of the plurality of parts.

2. The apparatus of claim 1 wherein each one of the plurality of parts is independently developed and wherein the adapter facilitates transparent communication between the individual, independently developed parts of the plurality of parts.

3. The apparatus of claim 1 wherein each different information communication format is a different format of Extensible Markup Language (XML).

4. The apparatus of claim 3 wherein the adapter is developed using Extensible Stylesheet Language Transformations (XSLT).

5. The apparatus of claim 1 and further comprising a parts host that loads the plurality of parts onto a page of the user interface at runtime.

6. The apparatus of claim 5 wherein the parts host loads the plurality of parts onto the page of the user interface in a configuration that is defined by page-level metadata.

7. The apparatus of claim 1 wherein rules for transforming information are defined by adapter-level metadata.

8. The apparatus of claim 1 wherein rules for transforming information are hard-coded into the adapter.

9. A method of developing a user interface for accessing programs available for use on a computer system, the method comprising:
establishing required functions for the user interface;
utilizing previously developed parts to provide the required functions, with each of the parts having a different associated information communication format; and
providing an adapter that is capable of receiving information in an information communication format of any one of the parts, and transforming the received information into an information communication format of any other one of the parts.

10. The method of claim 9 wherein each different information communication format is a different format of Extensible Markup Language (XML).

11. The method of claim 10 wherein the adapter is developed using Extensible Stylesheet Language Transformations (XSLT).

12. The method of claim 9 and further comprising providing a parts host that is capable of loading the parts onto a page of the user interface at runtime.

13. The method of claim 9 wherein the parts host loads the parts onto the page of the user interface in a configuration that is defined by page-level metadata.

14. The method of claim 9 wherein rules for transforming information are defined by adapter-level metadata.

15. The method of claim 9 wherein rules for transforming information are hard-coded into the adapter.

16. A system for facilitating communication between parts of a user interface that each have a different associated information communication format, the system comprising:
a parts host configured to load the parts onto a page of the user interface at runtime; and
an adapter configured to receive information in an information communication format of any one of the plurality of parts, and to transform the received information into an information communication format of any other one of the plurality of parts, thereby facilitating communication between individual parts of the plurality of parts.

17. The system of claim 16 wherein each different information communication format is a different format of Extensible Markup Language (XML).

18. The system of claim 17 wherein the adapter is developed using Extensible Stylesheet Language Transformations (XSLT).

19. The system of claim 16 wherein the parts host loads the plurality of parts onto the page of the user interface in a configuration that is defined by page-level metadata.

20. The system of claim 16 wherein rules for transforming information are defined by one of hard-coded instructions and adapter-level metadata.
